(19) United States
(12) Patent Application Publication
(10) Pub. No.: US 2003/0157225 A1
(43) Pub. Date: Aug. 21, 2003

(54) Food product and process

(76) Inventors: Alan James Husband, New South Wales (AU); Graham Edmund Kelly, New South Wales (AU)

Correspondence Address: FINNEGAN, HENDERSON, FARABOW, GARRETT & DUNNER, LLP, 1300 I STREET, NW, WASHINGTON, DC, 20005, US

(21) Appl. No.: 10/181,549

(22) PCT Filed: Jan. 22, 2001
(86) PCT No.: PCT/AU01/00057

(30) Foreign Application Priority Data
Jan. 21, 2000 (AU) PQ 5203

(51) Int. Cl. A23L 1/10

(52) U.S. Cl. 426/430

(57) ABSTRACT

Food products and pharmaceutical preparations containing one or more isoflavones are described. In particular, the invention relates to highly purified, crystalline isoflavones having an agreeable taste, texture and mouth-feel when formulated in food products and pharmaceutical preparations, and methods for the production of the highly purified, crystalline isoflavones.

### FIELD OF THE INVENTION

The present invention generally relates to food products and pharmaceutical preparations containing one or more isoflavones. More particularly, the invention relates to highly purified, crystalline isoflavones, methods for their production, and uses of the highly purified isoflavones in food technology, food products and pharmaceutical preparations.

### BACKGROUND OF THE INVENTION

Plant isoflavones and their metabolites have attracted considerable attention in the medical literature due to the beneficial biological activities attributed to these compounds. Humans and other animals benefit from the administration or ingestion of isoflavone-containing plant matter and plant extracts. The biological benefits include estrogenic, anti-estrogenic, anti-oxidant, anti-inflammatory and anti-cancer functions. Further benefits attributed to isoflavones include vascular compliance and function, osteoporosis treatment, alteration of blood lipoprotein levels, decrease in the propensity of thrombogenic events and the stabilisation or reduction of symptoms of menopause. Biologically important isoflavones are found almost solely in leguminous plants, with clover, soy, kudzu and chickpeas having the highest known amount. There are four main plant isoflavones—represented by daidzein and genistein and their respective methylated ethers, formononetin and biochanin. The amount of any or all of these isoflavones required to deliver a beneficial health effect is thought to be typically in the range of 20-100 mg per day.

Plant isoflavones may be administered in whole foodstuffs such as soy, chickpeas and lentils. However, this is a highly unreliable means for obtaining specified isoflavones at predictable levels and ratios. Soy flour is widely regarded as a valuable source of plant isoflavones and typically has isoflavone levels in the range of 100-300 mg/100 g. The isoflavone content however is represented predominantly by genistein and daidzein as soy contains almost negligible levels of the methylated isoflavones, formononetin and biochanin. Chickpeas and lentils typically contain all four isoflavones, but at levels at about one-tenth that of soy flour. Furthermore, isoflavone types and content are also widely variable depending on breeding background (strain and cultivate), age of plant, environmental conditions and stress, storage conditions of plant products and cooking and preparation. Therefore it would be very difficult if not almost impossible for the ordinary person to derive a predetermined amount of a particular isoflavone for a particular health benefit by relying on whole foodstuffs. The variable nature of the isoflavone content and the relatively small amount of isoflavone content per gram of whole food product would require the ingestion of significant amounts of whole food to achieve a desired, if perhaps unpredictable, result. For these reasons, it is widely regarded as desirable to extract isoflavones in semi-pure form and to deliver them as dietary supplements in foodstuffs or pharmaceutical preparations in specified amounts. In this way, the consumer derives the benefit of convenience and an assured amount of isoflavone.

There is an additional benefit from making isoflavones available in concentrated form. There is strong evidence that each of the four major estrogenic isoflavones in the human diet (daidzein, genistein, formononetin, biochanin) have distinctive biological properties and that selective health benefits can be obtained by administering particular isoflavones or combinations thereof at specific levels. It is highly unlikely that an individual seeking such benefit could achieve a diet containing specified levels of particular isoflavones or a particular ratio of isoflavones using natural dietary means. For this purpose, it is desirable to be able to manufacture isoflavone extracts with specified and variable isoflavone ratios.

Numerous references have been made in the scientific literature to the administration of phytoestrogens and isoflavonoids in foodstuffs and drinks. As previously described, the isoflavones in these additives may be in varied concentrations and variable isoflavone ratios, and with astringent flavours.

WO 00/64276 (Chen et al) describes a water-in-oil spread that contains phytoestrogens and isoflavanones with calcium and vitamins, for beneficial health effects. The spread may also contain sterols and sterol esters, stanol and stanol esters, and soy protein.

The patent specification “Health supplements containing phyto-estrogens, analogues or metabolites thereof” (Kelly WO 93/23069) teaches that isoflavones can be extracted from plants such as legumes, rendered to a dry powder form, and such form conveniently formulated into foodstuffs such as bread, confectionery or drinks, or into pharmaceutical compositions such as tablets or capsules.

Crank et al U.S. Pat. No. 5,858,449 describes isoflavone-enriched soy protein products and the methods for their manufacture. Crank's product has a desirable flavour and may be placed in dairy or meat-based food products such as infant formula, nutritional beverage, milk replacer, bologna, imitation processed cheese spread, yoghurt and frozen dessert.

Kelly and Joannou WO 98/08503 disclose the administration of an isoflavone-type compound used for various conditions. It may be used as a food additive in drinks and health bars.

Gorbach et al U.S. Pat. No. 5,498,631 describes a method for treating symptoms of menopause, premenstrual syndrome or conditions arising from reduced estrogen levels by administering an effective amount of an isoflavonoid. Said isoflavonoid may be delivered orally as a confectionary-bar, biscuit, cereal or beverage.

Gorbach U.S. Pat. No. 5,733,926 describes a method for the treatment of Alzheimer's disease or age-related loss of cognitive function comprising specific isoflavonoids. Administration may be in a food product such as a confectionary bar, biscuit, cereal or beverage.

Barnes et al U.S. Pat. No. 5,506,211 describes the administration of a genistein/glucoside conjugate, in various forms including foodstuffs such as soy, for the inhibition of acid secretion of osteoclasts and reduction of bone resorption.

Feuer et al U.S. Pat. No. 4,163,746 describes 5-methylalkoxy isoflavones useful as weight gain promoters. The composition of the product may be in liquid or solid form, and may contain other beneficial additives such as vitamins and amino acids.

Jackson et al U.S. Pat. No. 5,654,011 discloses a dietary supplement for increased nutrition of peri-menopausal women containing 8 to less than 50 mg of phytoestrogens, with various vitamins and minerals. This supplement may be delivered as a tablet, capsule, powder, gel or liquid, or dietary bar.

Kuznicki et al U.S. Pat. No. 5,464,619 describes a composition, preferably in the form of a beverage, which contains green tea solids, flavanols, sodium and potassium ions and carbohydrates.

Zilliken U.S. Pat. No. 4,157,984 describes a tempeh-based product used as an antioxidant in food compositions. This product may be used alone or in combination with isoflavones or other compounds. Zilliken U.S. Pat. No. 4,390,559 uses isoflavones as antioxidants for stability of edible fats and oils.

Shylankevich U.S. Pat. No. 5,424,331 discloses a treatment or prevention of osteoporosis which includes one or more phytoestrogen compounds and other minerals. Administration may be as a dietary supplement or as a pharmaceutical.

Potter et al U.S. Pat. No. 5,855,892 discloses administration of daidzein as a dietary supplement or as a pharmaceutical for the beneficial alteration of cholesterol levels.

Shylankevich U.S. Pat. No. 5,569,459 describes the use of phytoestrogen compounds for the regulation of estrogen production.

Schouten Industries WO 9610341 discloses use of soybean hypocotyls as sources of isoflavones. The material may be used in drinks, dairy products, bakery products, health teas and other products. Schouten USA Inc. currently produce a soybean isolate product called SoyLife, which may be included in various foods and dietary drinks. Additionally, Archer Daniels Midland (ADM) produces a dietary supplement called Novasoy, which is rich in genistin and daidzin.

Internutria WO 9821947 describes a food or drink containing phytoestrogen and melatonin, for the alleviation of persistent reproductive transition night time symptoms.

Many of the references above describe the difficulties encountered in promoting the ingestion of isoflavone extracts and concentrates due to their often disagreeable taste and unpleasant mouth feel resulting from the nature and composition of the isoflavone extracts and the form in which they are presented.

A number of methods are in common use for the preparation of isoflavone-enriched extracts (for example, see Barnes S, Kirk M and Coward L Isoflavones and their conjugates in soy foods: extraction conditions and analysis by HPLC-Mass Spectrometry. J Agric Food Chem 1994, 42:2466-74). The particular method depends largely on whether the isoflavones are contained in the starting material as glycosides or aglycones. The natural form for isoflavones in plants is as glycosides, that is, bound to a sugar moiety such as glucose and these are present either as simple glycosides or less commonly in malonyl or acetomalonyl forms. The various glycosidic forms of isoflavones are highly soluble in water but poorly soluble in organic solvents. In contrast, the free aglycone form is poorly soluble water but highly soluble in most polar organic solvents. Extraction of isoflavones from plant material such as red clover leaves, kudzu or soybeans, or from by-products of the food industry such as soy molasses or soy whey generally involves contacting the raw material with water, an organic solvent or a combination of water and organic solvent. Any or all of these extraction procedures have the disadvantage that the process is non-selective. If glycosides are extracted in an aqueous medium, then hundreds of other water-soluble plant components are similarly extracted. Likewise, if the aglycones are extracted in an organic solvent phase, then hundreds of other polar organic plant compounds such as saponins, sterols, and flavones also follow the isoflavones non-selectively into the solvent phase. These various extraction methods typically yield end-products with an isoflavone content of between 5-40%, but more usually between about 10-20%. The presence of such a high level of non-isoflavone contaminants usually results in the end-product having an unpleasant taste and rendering the product unattractive as a food ingredient. This usually necessitates the use of masking agents such as sugar in order to make the mixture palatable. For pharmaceutical use where the material is contained within a capsule or the like, such astringency is not usually a problem although the bulky nature of the material often makes the final formulation unacceptably bulky.

A number of further steps including selective use of a variety of organic solvents and chromatography are well known as being suitable for increasing the purity of isoflavones. The disadvantage of such processes is (a) that they generally produce low yields of isoflavones, (b) that they are expensive, and (c) that they are not economically viable for commercial scale-up. Also, no methods are described that are suitable for commercial scale and that lead to selective or preferential isolation of particular isoflavones. For this reason, the preparation of isolates containing specified ratios of isoflavones is not described in the art.

A requirement accordingly exists for isoflavone extracts and compositions that can be used as food additives and that have the advantages of (a) sufficiently high purity to be palatable or to have a negligible taste, and (b) desirable features of texture and miscibility that facilitates their ready incorporation into a wide variety of foodstuffs. Such properties also are of considerable commercial and practical advantage in the use of such extracts and compositions in pharmaceutical preparations. A further requirement also exists for such isoflavone extracts and compositions to have specified isoflavone ratios.

### SUMMARY OF THE INVENTION

It has been surprisingly found by the present inventors that highly purified forms of plant isoflavones can be isolated in workable quantities in a highly-purified crystalline form. The purified isoflavones can be formulated in food and health supplement products having an agreeable taste, texture and mouth feel. Advantageously the highly purified isoflavones can be incorporated into general food products to allow for the ingestion of these important isoflavones in the course of an ordinary diet. Food products such as spreads, margarines, oils, dressings, breakfast cereals and the like can contain efficacious amounts of desired plant isoflavones whilst not compromising the flavour or mouth feel of the food product.

The process according to the invention generally involves the extraction of isoflavone-containing plant material such as clover leaves or ground soya beans with an aqueous organic solvent mixture, the removal of large molecular weight compounds by passage through a fine gauge filter, the selective crystallization of isoflavones by reducing the organic solvent phase by evaporation, and the final recovery of the crystallised isoflavones. The resulting isoflavone product is most preferably in an alpha-crystalline form, which form has a high degree of purity, is virtually colourless, odourless and has an agreeable taste, texture and mouth feel.

Thus according to a first aspect of the invention there is provided a method for the production of an alpha-crystalline form of isoflavones comprising the steps of extracting isoflavones from isoflavone-containing plant matter by contacting the isoflavone-containing plant matter with an aqueous organic solvent mixture to give an extract solution; filtering the extract solution to reduce the amount of plant matter having a molecular weight greater than that of the isoflavones; reducing the solvent in the filtered solution to effect alpha-crystallisation of the isoflavones; and recovering the alpha-crystalline isoflavones.

According to a second aspect of the invention there is provided a method for the production of an alpha-crystalline form of isoflavones comprising the steps of extracting isoflavones from isoflavone-containing plant matter by contacting the isoflavone-containing plant matter with an aqueous organic solvent mixture to give an extract solution; filtering the extract solution to reduce the amount of plant matter having a molecular weight greater than that of the isoflavones; reducing the solvent in the filtered solution to effect alpha-crystallisation of the isoflavones; recovering the alpha-crystalline isoflavones; dissolving the recovered isoflavone crystals in an organic solvent; gradually reducing the volume of the organic solvent to effect the selective alpha-crystallisation of isoflavones; and isolating the selective alpha-crystalline isoflavones.

According to a third aspect of the present invention there is provided alpha-crystalline isoflavones prepared by a method of the first or second aspects of the invention. The alpha-crystalline isoflavones have an isoflavone content of greater than 50%, more preferably greater than 65%. The selective alpha-crystalline isoflavones have an isoflavone content of greater than 80%, more preferably greater than 90%.

According to a fourth aspect of the invention there is provided an alpha-crystalline form of isoflavones. The alpha-crystalline form is colourless, odourless and virtually tasteless when formulated in food preparations and products. The alpha-crystalline form of the isoflavones is typically substantially pure.

According to a fifth aspect of the present invention there is provided a food product or pharmaceutical preparation containing one or more highly purified isoflavones.

According to a sixth aspect of the invention there is provided a method for the manufacture of a food product or pharmaceutical preparation including the step of bringing an alpha-crystalline form of isoflavones into admixture with one or more ingredients in said food product or pharmaceutical preparation, wherein the alpha-crystalline form is substantially colourless, odourless and virtually tasteless when formulated in said food product or pharmaceutical preparation. Preferably the alpha-crystalline isoflavones are comminuted or pulverised before being formulated into said food product or pharmaceutical preparation

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

### DETAILED DESCRIPTION OF THE INVENTION

Isoflavones for use in the methods and compositions of the present invention may be sourced from whole plant material, synthetic or derivatised isoflavones or isoflavone precursors and prodrugs. A readily available source of isoflavones is from the whole plant material of clover where the isoflavones are mostly contained within the leaves of the plant.

Suitable clovers include red clover (T. pratense), subterranean clover (T. subterranean) or white clover (T. repens). Other suitable isoflavone-containing plant material includes a range of other legumes such as kudzu, soya beans and chickpeas. By choosing different types and amounts of isoflavone-containing plant material, the isoflavone content of the extracts isolated therefrom can be controlled. It is also possible to use certain types of clovers which are, for example, high in formononetin, or an alternative clover may be selected for the predominance of a different isoflavone such as biochanin.

In the case of leafy plant material such as with clovers, extraction of the plant isoflavones is typically achieved by crushing or chopping the leaves prior to the solvent extraction process. It is preferred to extract the isoflavones in their aglycone form. Crushing, chopping or comminuting the leaves and plant matter releases glucosidases contained within the plant and results in the enzymatic cleavage of the isoflavone glycosides to the corresponding aglycones. In the case of more inert material such as soy flour or waste-stream material from soy processing, breakage of the glycosidic bonds may be achieved by techniques such as hydrolysis with exposure to heat and/or acid, or by enzymatic treatment as known by those skilled in the art.

The comminuted or chopped plant matter is extracted with a solvent, which is generally water and an organic solvent, and preferably a water-miscible organic solvent. The ratio of water to organic solvent may generally be in the range of 1:10 to 10:1 and may for example comprise equal proportions of water and solvent. Any organic solvent or a mixture of such solvents may be used. The organic solvent may preferably be a C2-10, more preferably a C1-4 organic solvent (such as methanol, ethanol, isopropanol, butanol, butane dialyl, propylene glycol, erythritol, chloroform, dichloromethane, trichloroethane, acetonitrile, ethylene glycol, ethyl acetate, methyl acetate, glyceroldihydroxyacetone, tetrahydrofuran, ether or acetone) most preferably a C1-4 alcohol such as ethanol. The extract in this regard may be prepared by contacting the plant material with the water-solvent mix by well known methods in the art. Optionally the mixture may include an enzyme which assists in the cleavage the isoflavone glycosides to the aglycone forms. The mixture may be vigorously agitated so as to form an emulsion. The mixture may also be let stand to allow the enzymatic degradation to progress. The temperature of the mix may range, for example, from an ambient temperature to the boiling point of the solvent. Exposure time may be between 1 hour to several weeks. The extract may be physically separated from undissolved plant material by such common methods as filtration, centrifugation or settling or other standard procedures.

It has been surprisingly found by the inventors that the aglycone isoflavones in the resulting solvent display a distinctively different pattern of behaviour in organic solvents depending on the presence or absence of compounds with a higher molecular weight. It is found that when the resultant aqueous slurry is passed through a filter in order to remove particulate, undissolved plant material as well as dissolved or suspended plant material with molecular weights greater than that of the isoflavones, the isoflavones behave distinctly different than when the amount of those compounds of higher molecular weight are not substantially reduced or removed in their entirety. In particular, it has been found possible to induce the isoflavones to form alpha-crystals in the absence of high molecular weight plant compounds. Without wishing to be limited to theory, it is believed that the filtration step results in the desired alpha-crystalline isoflavone precipitating from the isoflavone-containing organic solvent concentrate.

Filtration is achieved by forcing the aqueous organic solvent mixture through a fine gauge physical separation barrier. Typically this is an ultra-filtration device comprising plastic or paper filters that block compounds with molecular weights greater than about 500. This process will remove most of the proteins, carbohydrates, lipids, oils and resins and chlorophyll leaving a generally clear, colourless liquor.

The resultant aqueous organic solvent mixture then is subjected to a process that effects a reduction in the level of organic solvent in the mixture. Most readily this is achieved in a rotary evaporator. When the level of organic solvent in the aqueous mixture reaches a critical point, there is noticeable precipitation of the isoflavones in an alpha-crystalline form. Typically this occurs within a narrow range of water:organic solvent ratio. The evaporation may be cancelled at this point and the crystals collected either by simple sedimentation or by filtration. When dried in an oven or simply at ambient temperature, the isoflavones typically have a purity of between 65-75%, are relatively colourless and odourless, display only slight astringency, represent a recovery yield of >90% of the staring isoflavones, and display an isoflavone ratio similar to that in the starting mixture. This isoflavone product may be regarded as a final product for incorporation into food products or pharmaceutical preparations.

Moreover, it may be desirable to effect a greater degree of purity of isoflavones in the final product or to isolate selective isoflavones. Further crystallisation is required to effect either or both of these outcomes. To this end, the crystals from the first wave of crystallisation are dissolved in an organic solvent. The solvent is preferably a water-immiscible solvent such as a C1-4 ester or ether. The solvent of choice is ethyl acetate. The solution is again placed in a rotary evaporator and the solvent volume gradually reduced. At a critical point in this process, there is a first wave of crystallisation, followed by a second wave when the level of solvent is further reduced. Careful control over the rate of evaporation of the solvent allows ready separation of the first and second waves of crystallisation. It is found that the first wave of crystals is predominantly formononetin and daidzein with between about 8-12% biochanin and genistein. It is also found that the second wave of crystals is predominantly biochanin and genistein with between 5-25% formononetin and daidzein. Each of these two waves of crystals can be collected and dried separately. It is found that in each case the isoflavone content of the dried material is in the range 90-95%. Alternatively, it may not be desired to separate the final two crystallisation steps. The crystallisation can be conducted as a single event and the crystals recovered only after the second wave of crystallisation.

The crystals collected by filtration are air-dried and reduced to a fine powder by methods well known in the art, such as by hammer mill or ball mill. The resultant fine powder is mostly colourless, odourless and virtually tasteless, especially when formulated in food products and pharmaceutical preparations. This makes the crystalline products particularly well suited as a food additive without the need for taste-masking of the isoflavone product crystals. In addition the fine-powdered alpha-crystalline isoflavones of the present invention have been found to blend well in various food processing methods. Addition of the isoflavone-enriched crystals will not significantly increase the volume of the food product or pharmaceutical preparation, and are readily incorporated into said preparations.

Use of membrane technology has allowed the present inventors to recover isoflavones in high yield and high purity, whilst maintaining physiological activity and function. Before this invention, the current process for isolating and recovering isoflavones involved the evaporation of organic solvents from an organic/aqueous solvent mixture to precipitate crude isoflavones which are then recovered. The recovered isoflavones may be re-extracted into an organic solvent, washed with water to remove water soluble impurities and re-precipitated to give the crude isoflavone extract. The present inventors have found that purification of the isoflavone extracts may be conveniently performed by the use of ultrafiltration membranes on the initial isoflavone extract. The use of an F4 membrane was found to be particularly useful in removing substantial amounts of isoflavone impurities having molecular weights greater than that of the isoflavones themselves.

The role of the ultrafiltration process is to purify the crude extract before the sequence of solids recovery by evaporation and subsequent organic re-extraction and precipitation. The impurities removed are generally biopolymeric gums in nature and are found to interfere with the predictability of processing and quality control of the product in downstream operations. Furthermore, the gum component reduces product activity significantly, adds colour (brown and green), co-precipitates with isoflavones and is particularly soluble in organic solvents.

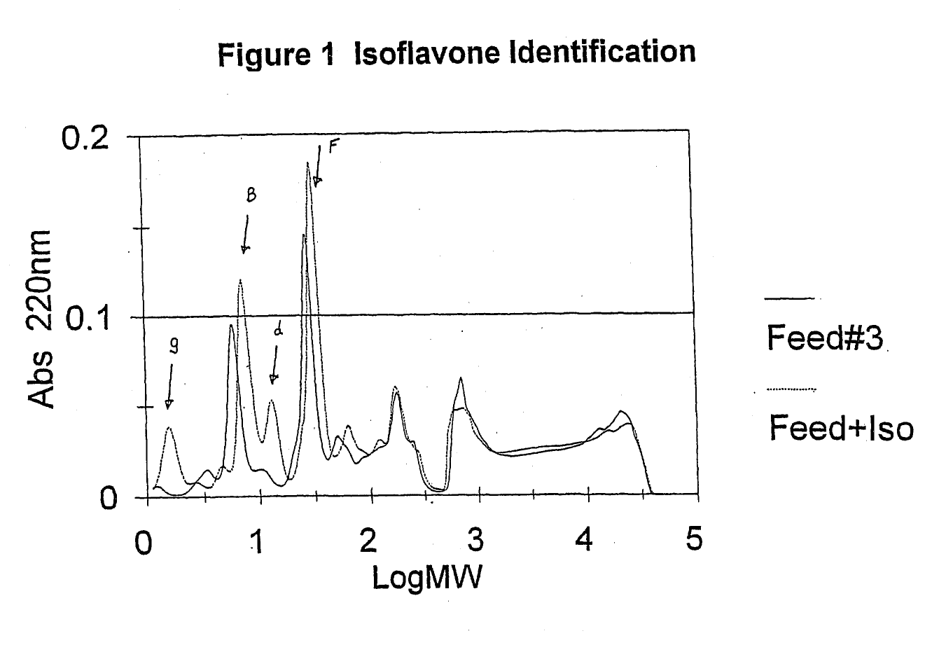

The function of the ultrafilter is to prevent molecules larger than a certain size from passing through the filter. The most effective ultrafilters of the present invention are those which are selected to be smaller than the biopolymer impurities, but larger than the isoflavones of interest. As can be seen from FIGS. 1-6, membrane F4 provided isoflavones at very high purity and much higher concentration than other membranes tested.

The effect of ultrafiltration on product activity is shown in the attached FIGS. 1-8 and summarised in table 1 below. Table 1 contains an analysis of an isoflavone extract (feed#3) subjected to various ultrafiltration membranes listed in order of decreasing membrane cut-off.

“Filtrate Solution” results show that the first six entries were unaltered in isoflavone content (0.069±10.005%) and ratio (0.85±0.06), which indicates that isoflavones passed easily through the membranes. Membranes Y3 and F4 caused a reduction in isoflavone concentration, due to the membrane cut-off being very close to the size of the isoflavone molecules. Even so, membranes Y3 and F4 produced no change in isoflavone ratio.

“Product Solids” data describes the composition of solids recovered by precipitation from the filtrate solutions. The dominant effect of membrane filtration was to elevate product activity. The control (no filtration) produced an activity of 47.1%, which was exceeded significantly by every membrane treatment. Membranes Y3 and F4 produced activities well in excess of the target range of 40 to 70%.

The reason for elevation of activity was the removal by ultrafiltration of certain biopolymeric; impurities, which co-precipitate with isoflavones from 15% alcohol and also co-extract into ethyl acetate. Product activity for membrane F4 was trimmed (76.5% vs 85.2%) because of the retarded passage of isoflavones, compared to impurity salts and sugars which passed unhindered.

In the final column of Table 1, control produced a ratio of 0.755, which was marginally lower than the feed range due to the higher residual solubility of Biochanin in 15% alcohol. Allowing for this solubility effect, product ratios for all membranes except F4 (0.85) were in the expected range of 0.69 to 0.81.

TABLE 1
Analyses of Ultrafiltration Samples

| Feed #3 | Filtrate Solution | | Product Solids | |
|---|---|---|---|---|
| Membrane | Isoflavone % | Ratio | Activity % | Ratio |
| None | 0.074 | 0.81 | 47.3 | 0.73 |
| None | 0.065 | 0.91 | 47.0 | 0.78 |
| K1 | 0.063 | 0.91 | 52.7 | 0.78 |
| K1 | 0.072 | 0.82 | 62.6 | 0.76 |
| K1K1 | 0.068 | 0.82 | 64.1 | 0.77 |
| Oml | 0.073 | 0.79 | 63.4 | 0.71 |
| Y3 | 0.055 | 0.83 | 85.2 | 0.77 |
| F4 | 0.023 | 0.92 | 76.1 | 0.85 |

Table 1 above highlights the advantages of ultrafiltered products compared to microfiltered products. It is expected that microfiltered product solids would be comparable to that of the controls above with no membrane, i.e. wherein the isoflavone extracts have about 47% activity and a ratio of about 0.75. This shows that microfiltration of the crude isoflavone extract slurry is simply a process improvement, whereas the ultrafiltration of crude extract leads to product improvement.

The effect of ultrafiltration is to remove flocculating impurities, which means that isoflavones are able to crystallise, preferably in their alpha-form, rather than be forced down by flocculation. Thus ultrafiltration substantially upgrades process capability in terms of product activity, without compromising yield. The ultrafiltration step can de-gum raw clover extract by the removal of chlorophylls and biopolymers that cause flocculation and add colour and mass to any degree of purity desired. Importantly, the isoflavone extracts subjected to the ultrafiltration step are substantially colourless, odourless and virtually tasteless, especially when formulated in food products and preparation.

The crystalline isoflavone products of the present invention represent a substantial improvement over the phytoestrogen extracts previously known. For example the water-in-oils spread described in Chen et al (WO 00/64276) includes a phytoestrogen extract containing other plant components and impurities. These contaminants such as soy proteins, sterols and sterol esters, stanols and stanol esters, plant gums, chlorophylls and biopolymers are either not present or are present in significantly reduced quantities in the crystalline isoflavones of the present invention. These contaminants typically impart undesirable colour, an astringent taste and unpleasant mouth feel to food products containing them.

Therefore, the alpha-crystalline form of the isoflavone products have found use as an important ingredient in food products such as spreads, margarines, butter products, oils, dressings, breakfast cereals, bread products, beverages and the like. The blending of the crystalline isoflavones into the various types of food products can be achieved by standard methods known to those skilled in the art. The flavour and mouth feel of the food product is not compromised by the presence of the isoflavone crystalline products of the present invention. This allows for beneficial isoflavones to be administered to the general public, as desired, in the course of their ordinary diet. By selecting a particular food product or pharmaceutical preparation the alpha-crystalline isoflavones, the benefits of ingesting plant isoflavones can be achieved without the need for making a conscious effort of supplementing the diet with pills and capsules containing isoflavone extracts.

The invention is further described in and illustrated by the following Examples. The Examples are not to be construed as unnecessarily limiting the invention in any way.

### EXAMPLE 1

### Alpha-Crystalline Form of Isoflavones

Freshly harvested red clover (100 kg) was macerated and rolled within two hours of harvesting. The macerated clover was left to stand at ambient temperature for six hours to allow for enzymatic degradation processes to convert the isoflavones from their glycoside to aglycone forms. The macerated clover was then contacted with 1000 litres of 50% ethanol in water for four hours at room temperature with continuous stirring and agitation. The steep liquor then was separated from the residual plant material by pressing through a grate or slotted rotating drum.

The steep liquor then was subjected to an ultra-filtration step by passing the liquor through a series of cartridges containing polyethylene filters. The primary filter had a cut-off pore size of 1,000-10,000 MW and the secondary filter a cut-off pore size of 500-1000 MW. The liquor was forced through the filters at a pressure of about 2000 kpa.

The ultra-filtered steep liquor was distilled under reduced pressure and the solvent reduced from about 50% ethanol to approximately 10% ethanol in water. At about this point in the evaporation process there was substantial crystallization of the isoflavones. The rate of evaporation was slowed and the ethanol content in the solvent reduced by about a further 1-2% at which time it was observed that there was no flurther appreciable crystal formation. The distillation process was stopped at that time, the solvent and crystal suspension removed, and the crystals separated from the solvent on a paper filter, and air-dried and hammer-milled to a fine powder. The isoflavone content of the product was determined by high-pressure liquid chromatography.

The characteristics of this product are as follows:

| | |
|---|---|
| Physical appearance | pale yellow to colourless, odourless, slightly |
| | astringent taste |
| Isoflavone content | 78% pure |
| | 52% biochanin; 29% formononetin; 10% genistein; |
| | 9% daidzein |

### EXAMPLE 2

### Margarine Containing Alpha-Crystalline Isoflavones

Margarine spread was made from a margarine fat comprising sunflower/canola oil and a hard stock, which consisted of a randomly interesterified mixture of fully hardened palm kernel oil and fully hardened palm oil. The margarine fat was formulated into a margarine spread according to standard techniques known in the art where the margarine fat was blended with the powdered alpha-crystalline isoflavones prepared according to Example 1 together with additional ingredients including salt, skim milk and whey powder, emulsifiers, colour, flavours, vitamins and water. The margarine spread was formulated to contain 0.1% powdered isoflavone crystals w/w of margarine spread. The isoflavone-containing spread was not noticeably different in taste, appearance or mouth-feel from a control spread prepared without any added isoflavone crystals, in comparison, a red clover extract prepared without the ultrafiltration step imparted a disagreeable flavour, colour and texture to a spread made containing the extract.

### EXAMPLE 3

### Preparation of Different Isoflavone Ratios

Alpha-crystalline isoflavone preparation (1200 g) manufactured according to Example 1 was dissolved in ethyl acetate (50 litres). The solution was placed in a rotary evaporator and heat and vacuum was applied. A wave of crystallization occurred when the ethyl acetate volume was reduced to about 30 litres. Rotary evaporation was stopped at this point by release of the vacuum and the crystals were allowed to settle. The crystals plus solvent were removed and passed through a paper filter in order to collect the crystals. The filtered solvent then was returned to the rotary evaporator and further heat and vacuum applied. A second wave of crystallization occurred when about a further 10 litres of ethyl acetate was distilled off. These crystals were collected by filtration. Both batches of crystals were dried and ground to a powder.

The characteristics of these two products were as follows:

| | 1st crystalline product | 2nd crystalline product |
|---|---|---|
| Physical appearance | colourless, odourless, | colourless, odourless, |
| | tasteless | tasteless |
| Isoflavone content | 92% | 94% |
| Formononetin | 82% | 20% |
| Biochanin | 11% | 75% |
| Daidzein | 5% | 1% |
| Genistein | 2% | 4% |

### EXAMPLE 4

### X-Ray Powder Diffraction Data of Alpha-Crystalline Isoflavones

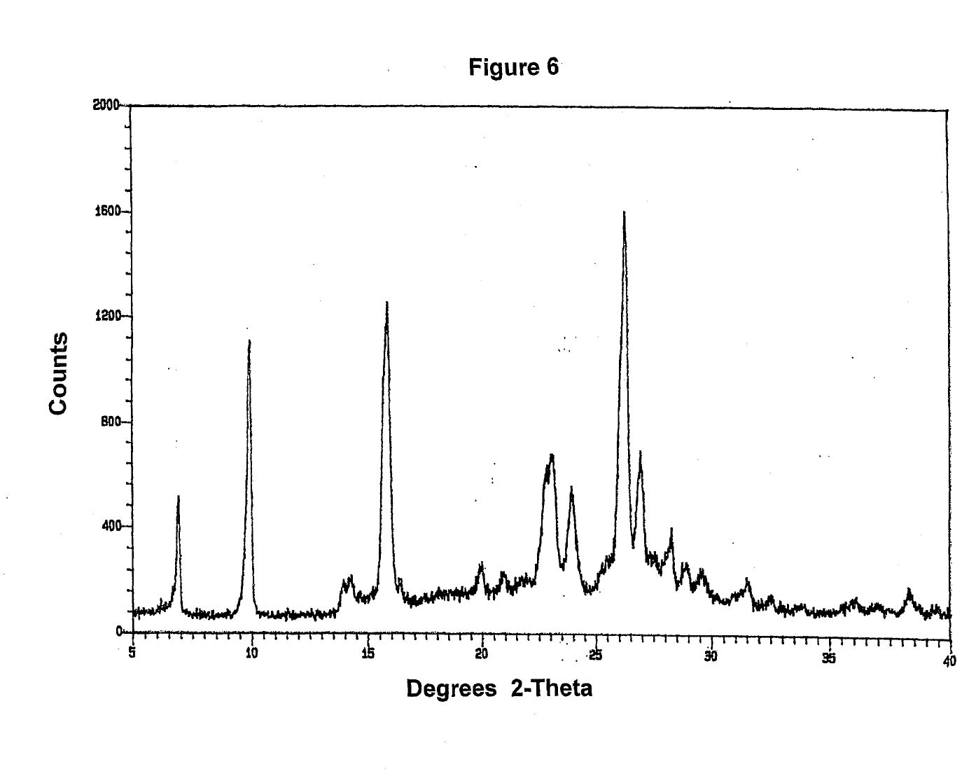

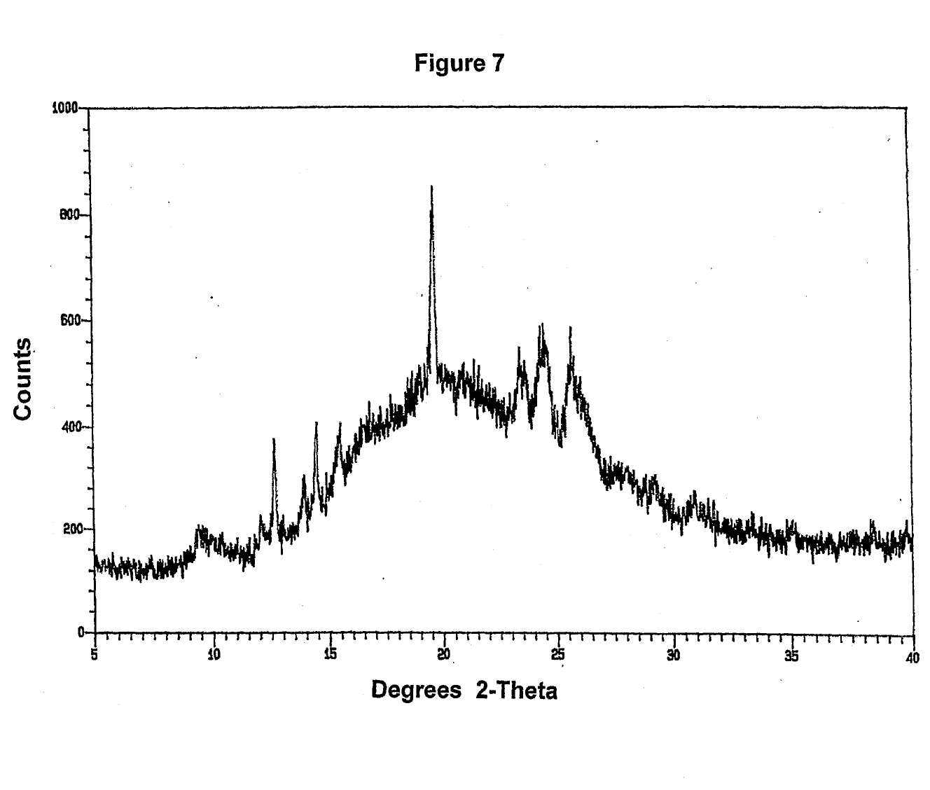

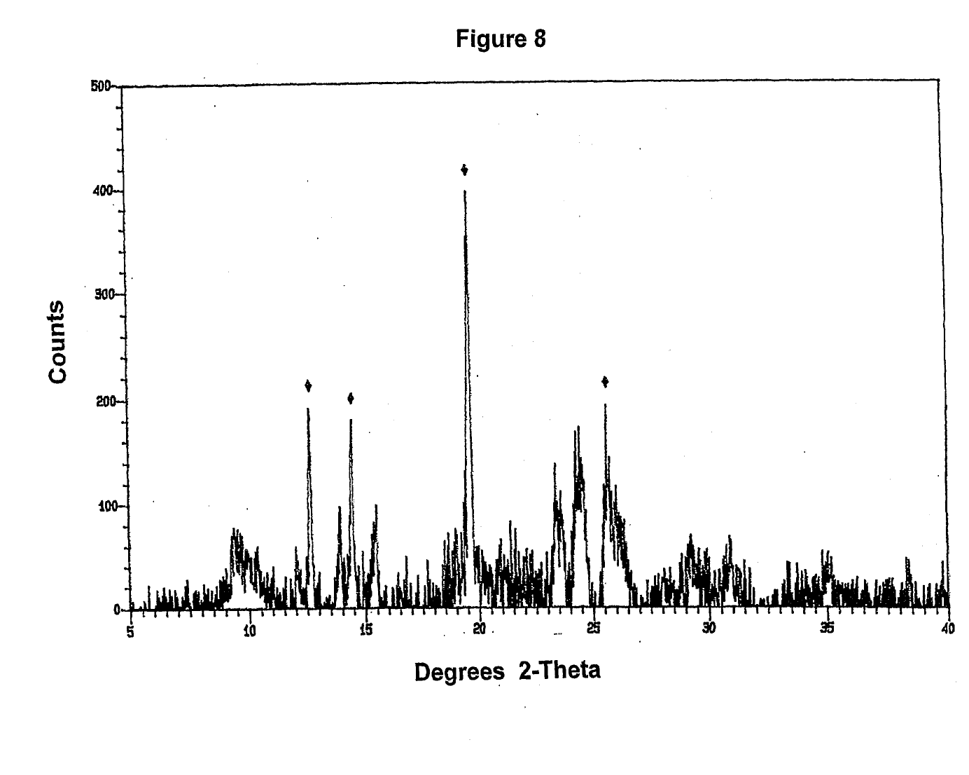

The alpha-crystalline isoflavones isolated in Example 1 was subjected to x-ray powder defraction. The plot of the x-ray powder defraction is shown in FIG. 6. In comparison, a “crude” red clover extract was subjected to the same x-ray powder defraction and the results are shown in FIG. 7, and in FIG. 8 where some of the noise has been removed. The crude red clover extract is currently used in the production of Promensil (Novogen). FIGS. 7 and 8 show the crude red clover extract to be an amorphous mix of substances. In contrast, the alpha-crystalline isoflavones are shown in FIG. 6 to have a more highly-ordered crystalline structure.

The X-ray powder diffractrogram shown in FIG. 6 for the alpha-crystalline isoflavones isolated in Example 1 indicate reflection signals (2 theta) of high and medium intensity (>30% relative intensity) as set out in Table 2 below:

TABLE 2
X-ray powder diffractogram of alpha-crystalline isoflavones.

| | | | | | | | | |
|---|---|---|---|---|---|---|---|---|
| 2 θ (2 theta) | 7.0 | 9.9 | 15.8 | 22.7 | 23.0 | 23.9 | 26.3 | 26.9 |

### EXAMPLE 5

### Analysis of Molecular Weight and Isoflavones

General Procedure

Samples were analysed by size exclusion chromatography in 50% alcohol to characterise the molecular size distribution of biopolymeric impurities. Coincidentally, it also produced an analysis of isoflavone distribution due to partial affinity.

The molecular weight range is indicative, rather than absolute, due to the effect of alcohol on the calibration of the column and the absence of closely related MW standards.

Isoflavone peaks were identified in the chromatogram by spiking a sample of clover extract (Feed#3) with a mixed standard of four isoflavones (FIG. 1). The isoflavones displayed affinity to the column and so eluted later than their actual size of 250 to 300 Daltons (ie, they appear at smaller LogMW of 0 to 1.7).

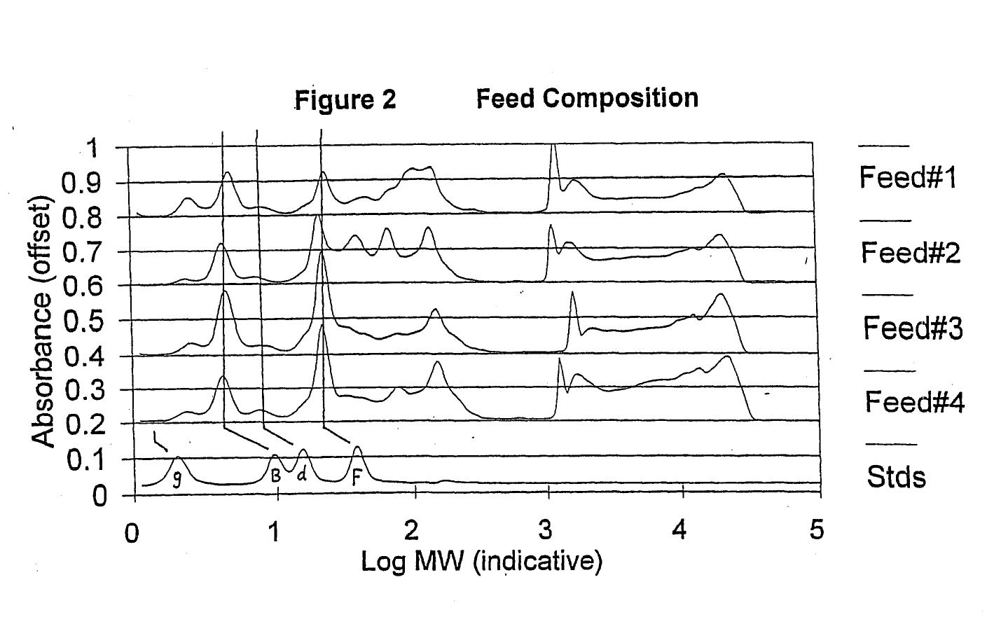

FIG. 2 shows that in a series of four different clover extracts, there are a many other small components at LogMW=0 to 2.5, which may be closely related to the isoflavones, as they display similar affinity that takes them past the end of the size exclusion separation at LogMW=2.5. The dominant UV absorbing small impurities occur at LogmW=1.5 to 2.5 in the range of four different clover extracts.

It is noted that the isoflavone standards do not coincide with the peak positions of isoflavones in the clover extracts. Being based upon affinity, their elution is affected by the type and amount of other components, which compete for interaction or passage through the column.

The size range of gums, or biopolymers, was about 1,000 to 40,000 Daltons. Green chlorophylls occur as the sharp peak near LogMW=3. The higher polymers at LogMW 3.5 to 4.5 are coloured yellow, brown, red-brown, or black depending on concentration. Biopolymers typically have low absorbances compared to small aromatic organic molecules, which means that the MW distributions shown here strongly underestimate the proportion of biopolymers present in the samples.

Microfiltration of Crude Isoflavone Precipitate

The recovery of crude isoflavones by precipitation from 15% alcohol was achieved using microfiltration. The finally disbursed, dilute suspension produced was concentrated to a dense slurry which remained fluid. Concentration of the slurry assisted in the precipitation of the isoflavone which were purified of water soluble component remaining in the filtrate.

The microfilter delivering the highest flux at highest pressure in long duration filtration tests was AF500, with the flux ranging from of 68 L.m⁻².h⁻¹ at 100 kPa to 45 L.m⁻².h⁻¹ at 200 kPa. Flux declined at higher pressure due to cake formation and compaction. Within an appropriate selection of poor size and use of low feed pressure, the filtrate was perfectly clear and without any trace of haze. A recovery of 95% of the isoflavones was obtained using the microfiltration step. By performing a second microfiltration to collect the post-filtration precipitate, the total isoflavone recovery was 99% for the two stages of microfiltration.

Ultrafiltration of Dissolved Isoflavone in 50% Alcohol

The ultrafiltration process purified the crude isoflavone extract before the sequence of rotary evaporation—solids recovery—ethyl acetate re-extraction. Ultrafiltration was found to remove the polymeric impurities (ie, de-gumming), which interfere with the predictability of processing and quality of product in those downstream operations. The gum component reduces product activity significantly, adds colour (brown and green), co-precipitates with isoflavones at 15% alcohol, and is partially soluble in organic solvents. As a pharmaceutical component, the gum fraction also presents difficulties because it is uncharacterised. The simplest and most desirable solution is its removal.

The crude extract was analysed by size exclusion chromatography to determine the molecular size and mass distribution, and this information used to select an appropriate ultrafilter. The function of the ultrafilter is to prevent molecules larger than a certain size from passing through the filter, which is perfectly analogous to haemodialysis or kidney function, and to the operation of plant cell walls in preventing the discharge of its genetic material and biochemical functions.

Ultrafilters are distinguished by pore size, which determines the molecular size cut-off, and is selected to be smaller than the biopolymers but larger than the small molecules of interest. Ultrafiltration of clover extracts with the tight membranes required to achieve purification, was in the range 1 to 10 L.m⁻².h⁻¹ at 400 kPa. This type of membrane is normally operated at pressure of 1000 to 2000 kPa, where the flux would be expected to be 5 to 25 L.m⁻².h⁻¹.

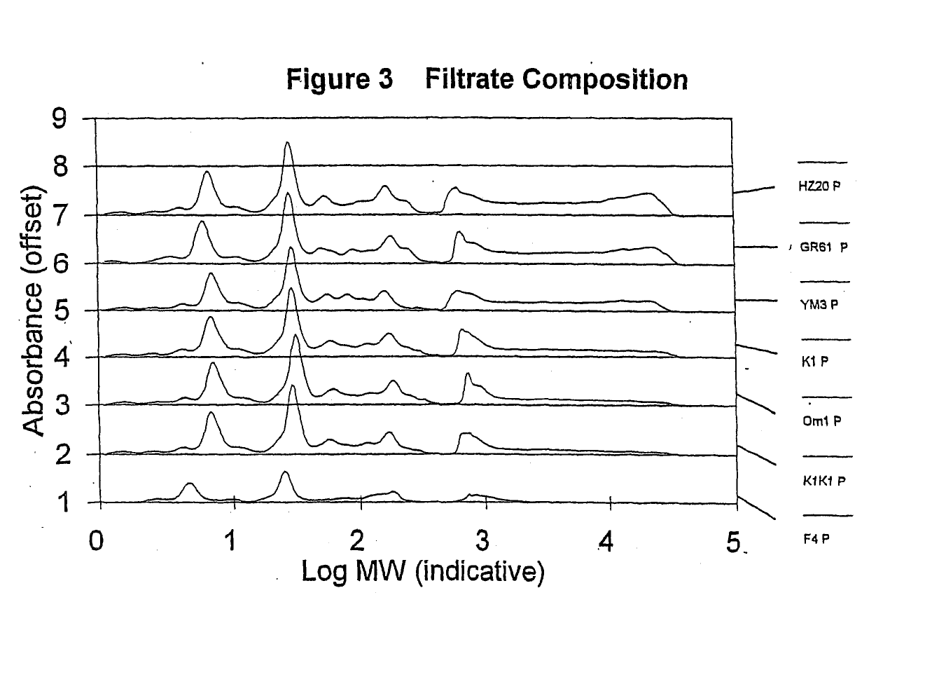

The chromatographic result that the upper MW was about 40 kD (FIGS. 1 and 2) was confirmed experimentally when it was found that all of the feed passed through a 50 kD ultrafilter (FIG. 3, membrane=HZ20 P, where P=permeate or filtrate sample). All of the permeate analyses in FIG. 3 were produced from the same feed (Feed#3) using different, progressively tighter, membranes. The biopolymer is progressively removed as the membrane becomes tighter, as shown by the series in FIG. 3.

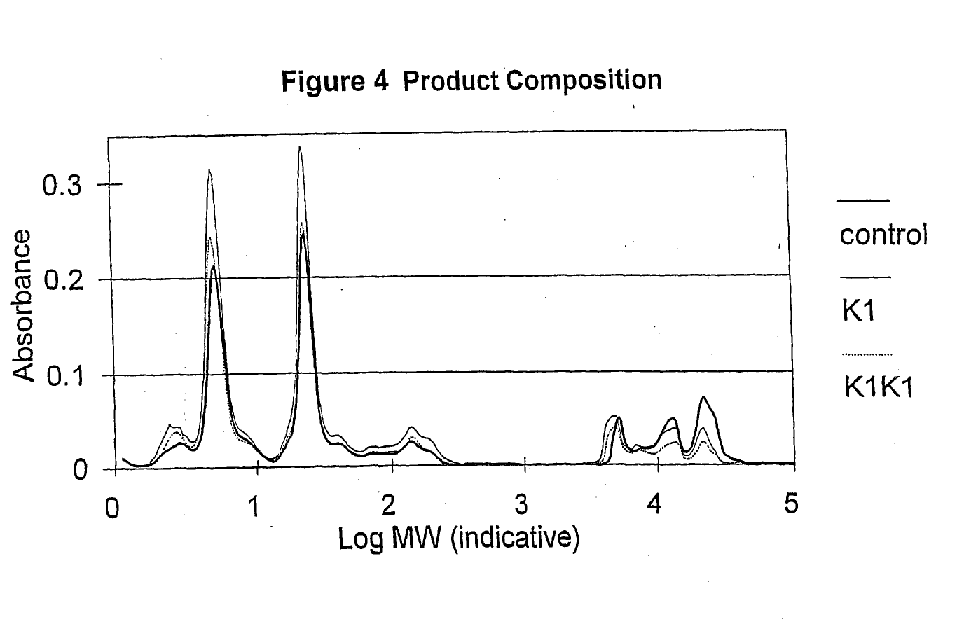

It can be seen that chlorophyll is strongly reduced by membrane F4. The only membrane to significantly affect the isoflavones and material at LogMW=1.8 to 2.5, was F4. While the reduction in isoflavone concentration retards the mass transfer of isoflavones through the process, this is outweighed by the tremendous gain in removal of impurities. Treatment K1K1 in FIG. 3 was the processing of Feed#3 through two stages of membrane K1 in series. The improvement in biopolymer removal by single stage (K1) and two stage (K1K1) ultrafiltration is shown more clearly in FIG. 4. The isoflavones remain unaffected, but the chlorophylls and biopolymers are reduced significantly. The purification obtained by K1K1 was superior to that using membrane Om1, even though Om1 is a tighter membrane than K1 (This phenomenon is fundamentally rational for multistage membrane processes).

De-gumming performance was inadequate for membranes HZ20, GR61 and YW3.

One of the purposes of ultrafiltration was to improve product quality. To demonstrate this, Feed#3 was ultrafiltered in 50% alcohol (control=no ultrafiltration), the filtrate was diluted with water to 15% alcohol, and the isoflavone product was collected on a micro filter, from which it was re-extracted into 50% alcohol. Analysis of the products shows that in both cases where ultrafiltration was used, the product extract contained a higher concentration of isoflavone and a lower concentration of biopolymer than the control.

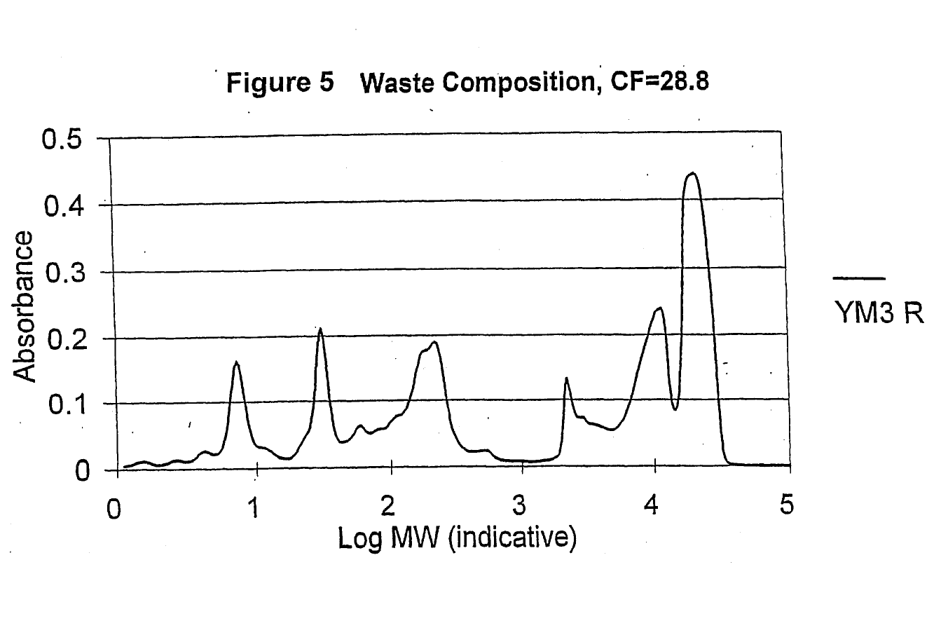

Furthermore, FIG. 5 shows a retentate sample in which the initial volume of feed has been reduced 28.8 fold by ultrafiltration. Compared to feed samples in FIG. 2, the biopolymer peaks were enhanced considerably, whereas the isoflavone peaks have remained unaltered. The yield loss of isoflavones into this retentate waste stream is the proportion that retentate volume is of feed volume. With a concentration factor of 28.8, the yield loss would be 3.5%. Tius loss can be further reduced by designing for even higher concentration factors or by re-extracting (diafiltration) the retentate.

The reference to any prior art in this specification is not, and should not be taken as, an acknowledgment or any form of suggestion that prior art forms part of the common general knowledge in the field of endeavor.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in the specification, individually or collectively, and any and all combinations of any two or more of said steps or features.

1. A method for the production of an alpha-crystalline form of isoflavones comprising the steps of:
(a) extracting isoflavones from isoflavone-containing plant matter by contacting the isoflavone-containing plant matter with an aqueous organic solvent-mixture to give an extract solution;
(b) filtering the extract solution to reduce the amount of plant matter having a molecular weight greater than that of the isoflavones;
(c) reducing the solvent in the filtered solution to effect alpha-crystallisation of the isoflavones; and
(d) recovering the alpha-crystalline isoflavones.

2. The method of claim 1 wherein the aqueous organic solvent mixture is in the range of 1:10-10:1 of water:organic solvent.

3. The method of claim 2, wherein the ratio is about 1:1 of water:organic solvent.

4. The method of any of claims 1-3, wherein the organic solvent is a C1-4 organic solvent selected from the group consisting of alcohols, chloroalkanes, glycols, alkyl esters and ethers.

5. The method of claim 4, wherein the organic solvent is ethanol.

6. The method of any of claims 1-5, wherein the alpha-crystalline isoflavones have an isoflavone content of greater than 50%, and preferably greater than 65%.

7. The method of any of claims 1-6, wherein the filtration step at step (b) of claim 1 is an ultrafiltration step.

8. A method for the production of an alpha-crystalline form of isoflavones comprising the steps of:
(a) extracting isoflavones from isoflavone-containing plant matter by contacting the isoflavone-containing plant matter with an aqueous organic solvent mixture to give an extract solution;
(b) filtering the extract solution to reduce the amount of plant matter having a molecular weight greater than that of the isoflavones;
(c) reducing the solvent in the filtered solution to effect alpha-crystallisation of the isoflavones;
(d) recovering the alpha-crystalline isoflavones;
(e) dissolving the recovered isoflavone crystals from step (d) in an organic solvent;
(f) gradually reducing the volume of the organic solvent to effect the selective alpha-crystallisation of iso flavones; and
(g) isolating the selective alpha-crystalline isoflavones.

9. The method of claim 8 wherein the aqueous organic solvent mixture is in the range of 1:10-10:1 of water: organic solvent.

10. The method of claim 9, wherein the ratio is about 1:1 of water:organic solvent.

11. The method of any of claims 8-10, wherein the organic solvent is a C1-4 organic solvent selected from the group consisting of alcohols, chloroalkanes, glycols, alkyl esters and ethers.

12. The method of claim 11, wherein the organic solvent is ethanol.

13. The method of any of claims 8-12, wherein the alpha-crystallised isoflavones have an isoflavone content of greater than 50%, and preferably greater than 65%.

14. The method of any of claims 8-13, wherein the filtration step at step(b) of claim 8 is an ultrafiltration step.

15. The method of claim 8, wherein the organic solvent from step (e) is a C1-4 ester or ether.

16. The method of claim 15, wherein the organic solvent is ethyl acetate.

17. The method of claim 8, wherein the selective alpha-crystalline isoflavones have an isoflavone content of greater than 80%.

18. The method of claim 17, wherein the selective alpha-crystalline isoflavones have an isoflavone content of greater than 90%.

19. The method of any preceding claim, wherein the selective alpha-crystalline isoflavones contain predominantly formononetin and daidzein.

20. The method of any preceding claim, wherein the selective alpha-crystalline isoflavones contain predominantly biochanin and genistein.

21. Alpha-crystalline isoflavones prepared by a method of any one of the preceding claims.

22. An alpha-crystalline form of isoflavones.

23. The alpha-crystalline isoflavones of claim 22, wherein the alpha-crystalline form is substantially colourless, odourless and virtually tasteless when formulated in food preparations and pharmaceutical products.

24. The alpha-crystalline isoflavones of claim 23, wherein the alpha-crystalline form contains isoflavones in excess of 50%.

25. The alpha-crystalline isoflavones of claim 24, wherein the alpha-crystalline form contains isoflavones in excess of 90%.

26. The alpha-crystalline isoflavones of claim 25, wherein the alpha-crystalline form is substantially pure.

27. A food product or pharmaceutical preparation containing one or more highly purified isoflavones.

28. The food product or pharmaceutical preparation of claim 27, wherein the highly purified isoflavones are in the alpha-crystalline form.

29. A method for the manufacture of a food product or pharmaceutical preparation including the step of bringing an alpha-crystalline form of isoflavones into admixture with one or more ingredients in said food product or pharmaceutical preparation, wherein the alpha-crystalline form is substantially colourless, odourless and virtually tasteless when formulated in said food product or pharmaceutical preparation.

30. The method of claim 29, wherein the alpha-crystalline isoflavones are comminuted or pulverised before being formulated into said food product or pharmaceutical preparation.

31. An alpha-crystalline form of isoflavones, wherein the crystalline form has an X-ray powder diffractrogram with the following reflection signals (2 theta) of high and medium intensity
```
2 θ (2 theta)
  7.0
  9.9
15.8
22.7
23.0
23.9
26.3
26.9
```
